(19) United States
(12) Patent Application Publication
(10) Pub. No.: US 2025/0349233 A1
(43) Pub. Date: Nov. 13, 2025

(54) DISPLAY APPARATUS AND ELECTRONIC APPARATUS INCLUDING THE SAME

(71) Applicants: Samsung Display Co., Ltd., Yongin-si (KR); UNIST(ULSAN NATIONAL INSTITUTE OF SCIENCE AND TECHNOLOGY), Ulsan (KR)

(72) Inventors: HYUNGSUK HWANG, Yongin-si (KR); Oh-Sang Kwon, Ulsan (KR); YOURA KIM, Yongin-si (KR); HYOSUN KIM, Yongin-si (KR); Seonggyu Choe, Ulsan (KR); Chang-Yeong Han, Ulsan (KR)

(21) Appl. No.: 19/197,629

(22) Filed: May 2, 2025

(30) Foreign Application Priority Data
May 9, 2024 (KR) 10-2024-0061304

(51) Int. Cl. G09G 3/00; G06F 3/01; G09G 3/20

(52) U.S. Cl. CPC G09G 3/001; G06F 3/013; G09G 3/2092; G09G 2320/0261; G09G 2340/0435; G09G 2354/00

(57) ABSTRACT

A display apparatus includes: a display panel; an eye tracker configured to track a view of a user; and a display panel driver configured to determine a central viewing area of the display panel and a peripheral viewing area of the display panel based on the view of the user, to drive the central viewing area of the display panel at a first duty ratio, and to drive the peripheral viewing area of the display panel at a second duty ratio, wherein the first duty ratio is less than the second duty ratio.

### CROSS-REFERENCE TO RELATED APPLICATION

The present application claims priority to and the benefit of Korean Patent Application No. 10-2024-0061304, filed on May 9, 2024, in the Korean Intellectual Property Office, the entire disclosure of which is incorporated herein by reference.

### BACKGROUND

### 1. Field

Aspects of some embodiments of the present disclosure relate to a display apparatus and an electronic apparatus including the display apparatus.

### 2. Description of the Related Art

Generally, a display apparatus includes a display panel and a display panel driver. The display panel includes a plurality of gate lines, a plurality of data lines and a plurality of pixels. The display panel driver includes a gate driver, a data driver and a driving controller. The gate driver outputs gate signals to the gate lines. The data driver outputs data voltages to the data lines. The driving controller controls an operation of the gate driver and an operation of the data driver.

The display apparatus may be a head mounted display apparatus. When the display apparatus is used as the head mounted display apparatus, display quality may be deteriorated and dizziness may occur due to motion blur of the display panel.

### SUMMARY

Aspects of some embodiments of the present disclosure relate to a display apparatus and an electronic apparatus including the display apparatus. For example, aspects of some embodiments of the present disclosure relate to a display apparatus adjusting a duty ratio of a display area or a frequency of the display area through an eye tracking and an electronic apparatus including the display apparatus.

Aspects of some embodiments of the present disclosure include a display apparatus in which a central viewing area and a peripheral viewing area emit light at different duty ratios or at different frequencies to reduce a perception degree of motion blur of the display panel.

Aspects of some embodiments of the present disclosure include an electronic apparatus including the display apparatus.

In a display apparatus according to some embodiments of the present disclosure, the display apparatus includes a display panel, an eye tracker and a display panel driver. According to some embodiments, the eye tracker is configured to track a view of a user. According to some embodiments, the display panel driver is configured to determine a central viewing area of the display panel and a peripheral viewing area of the display panel based on the view of the user, drive the central viewing area of the display panel at a first duty ratio and drive the peripheral viewing area of the display panel at a second duty ratio. According to some embodiments, the first duty ratio is less than the second duty ratio.

According to some embodiments, the display panel driver may be configured to analyze input image data to determine a first mode and a second mode. According to some embodiments, in the first mode, the display panel driver may be configured to drive the central viewing area of the display panel at the first duty ratio and drive the peripheral viewing area of the display panel at the second duty ratio. According to some embodiments, in the second mode, the display panel driver may be configured to drive an entire display area of the display panel at the first duty ratio.

According to some embodiments, in the first mode, backgrounds of an image may be fixed and an object may move in the backgrounds.

According to some embodiments, in the second mode, backgrounds of the image may change.

According to some embodiments, the display panel driver may include an emission driver configured to output an emission signal to the display panel. According to some embodiments, the emission driver may be configured to apply the emission signal having the first duty ratio to the central viewing area and the emission signal having the second duty ratio to the peripheral viewing area.

According to some embodiments, the display apparatus may further include a second display panel adjacent to the display panel, a second eye tracker configured to track a second view of the user and a second display panel driver configured to determine a central viewing area of the second display panel and a peripheral viewing area of the second display panel based on the second view of the user, drive the central viewing area of the second display panel at the first duty ratio and drive the peripheral viewing area of the second display panel at the second duty ratio.

According to some embodiments, the display panel may correspond to a left eye of the user. According to some embodiments, the second display panel may correspond to a right eye of the user.

According to some embodiments, the display panel driver may include a gate driver configured to output a gate signal to the display panel, a data driver configured to output a data voltage to the display panel, an emission driver configured to output an emission signal to the display panel and a driving controller configured to control the gate driver, the data driver and the emission driver. According to some embodiments, the second display panel driver may include a second gate driver configured to output a second gate signal to the second display panel, a second data driver configured to output a second data voltage to the second display panel, a second emission driver configured to output a second emission signal to the second display panel and a second driving controller configured to control the second gate driver, the second data driver and the second emission driver.

According to some embodiments, the display panel driver may include a gate driver configured to output a gate signal to the display panel, a data driver configured to output a data voltage to the display panel and an emission driver configured to output an emission signal to the display panel. According to some embodiments, the second display panel driver may include a second gate driver configured to output a second gate signal to the second display panel, a second data driver configured to output a second data voltage to the second display panel and a second emission driver configured to output a second emission signal to the second display panel. According to some embodiments, the display panel driver may further include a driving controller configured to control the gate driver, the data driver, the emission driver, the second gate driver, the second data driver and the second emission driver.

According to some embodiments, the display panel may include display blocks extending in a first direction and arranged in a second direction. According to some embodiments, the display panel driver may be configured to drive display blocks including the central viewing area of the display panel among all the display blocks at the first duty ratio and display blocks not including the central viewing area of the display panel among all the display blocks at the second duty ratio.

According to some embodiments, the display panel may include first display blocks extending in a first direction and arranged in a second direction. According to some embodiments, the display panel may further include second display blocks extending in the second direction and arranged in the first direction. According to some embodiments, the display panel driver may be configured to drive an area corresponding to an intersection of the first display blocks including the central viewing area of the display panel among all the first display blocks and the second display blocks including the central viewing area of the display panel among all the second display blocks at the first duty ratio. According to some embodiments, the display panel driver may be configured to drive an area not corresponding to the intersection at the second duty ratio.

In a display apparatus according to some embodiments of the present disclosure, the display apparatus includes a display panel, an eye tracker and a display panel driver. According to some embodiments, the eye tracker is configured to track a view of a user. According to some embodiments, the display panel driver is configured to determine a central viewing area of the display panel and a peripheral viewing area of the display panel based on the view of the user, drive the central viewing area of the display panel at a first frequency and drive the peripheral viewing area of the display panel at a second frequency. According to some embodiments, the first frequency is greater than the second frequency.

According to some embodiments, the display panel driver may be configured to analyze input image data to determine a first mode and a second mode. According to some embodiments, in the first mode, the display panel driver may be configured to drive the central viewing area of the display panel at the first frequency and drive the peripheral viewing area of the display panel at the second frequency. According to some embodiments, in the second mode, the display panel driver may be configured to drive an entire display area of the display panel at one of the first frequency and the second frequency.

According to some embodiments, the display panel driver may include an emission driver configured to output an emission signal to the display panel. According to some embodiments, the emission driver may be configured to apply the emission signal having the first frequency to the central viewing area and the emission signal having the second frequency to the peripheral viewing area.

According to some embodiments, the display apparatus may further include a second display panel arranged adjacent to the display panel, a second eye tracker configured to track a second view of the user and a second display panel driver configured to determine a central viewing area of the second display panel and a peripheral viewing area of the second display panel based on the second view of the user, drive the central viewing area of the second display panel at the first frequency and drive the peripheral viewing area of the second display panel at the second frequency.

In a display apparatus according to some embodiments of the present disclosure, the display apparatus includes a display panel, an eye tracker and a display panel driver. According to some embodiments, the eye tracker is configured to track a view of a user. According to some embodiments, the display panel driver is configured to determine a central viewing area of the display panel and a peripheral viewing area of the display panel based on the view of the user, drive the central viewing area of the display panel at a first duty ratio and a first frequency and drive the peripheral viewing area of the display panel at a second duty ratio and a second frequency. According to some embodiments, the first duty ratio is different from the second duty ratio, or the first frequency is different from the second frequency.

According to some embodiments, the first duty ratio may be less than the second duty ratio. According to some embodiments, the first frequency may be the same (or substantially the same) as the second frequency.

According to some embodiments, the first duty ratio may be the same (or substantially the same) as the second duty ratio. According to some embodiments, the first frequency may be greater than the second frequency.

According to some embodiments, the first duty ratio may be less than the second duty ratio. According to some embodiments, the first frequency may be greater than the second frequency.

According to some embodiments, the display panel driver may be configured to analyze input image data to determine a first mode and a second mode. According to some embodiments, in the first mode, the display panel driver may be configured to drive the central viewing area of the display panel at the first duty ratio and the first frequency and drive the peripheral viewing area of the display panel at the second duty ratio and the second frequency. According to some embodiments, in the second mode, the display panel driver may be configured to drive an entire display area of the display panel at the first duty ratio. According to some embodiments, in the second mode, the display panel driver may be configured to drive the entire display area of the display panel at one of the first frequency and the second frequency.

In an electronic apparatus according to some embodiments of the present disclosure, the electronic apparatus includes a display panel, an eye tracker, a display panel driver and a processor. According to some embodiments, the eye tracker is configured to track a view of a user. According to some embodiments, the display panel driver is configured to determine a central viewing area of the display panel and a peripheral viewing area of the display panel based on the view of the user, drive the central viewing area of the display panel at a first duty ratio and drive the peripheral viewing area of the display panel at a second duty ratio. According to some embodiments, the processor is configured to output input image data and an input control signal to the display panel driver. According to some embodiments, the first duty ratio is less than the second duty ratio.

According to the display apparatus and the electronic apparatus including the display apparatus, the central viewing area of the display panel and the peripheral viewing area of the display panel may emit light at different duty ratios or at different frequencies so that a perception degree of motion blur of the display panel may be relatively reduced.

According to some embodiments, the perception degree of the motion blur of the display panel may be relatively reduced so that the display quality may be relatively enhanced and the dizziness may be relatively reduced.

### BRIEF DESCRIPTION OF THE DRAWINGS

The above and other features and characteristics of embodiments according to the present disclosure will become more apparent by describing in detailed embodiments thereof with reference to the accompanying drawings, in which:

FIG. 1 is a diagram illustrating a display apparatus according to some embodiments of the present disclosure;

FIG. 2 is a block diagram illustrating the display apparatus of FIG. 1;

FIG. 3 is a diagram illustrating an experimental condition A;

FIG. 4 is a diagram illustrating an experimental condition B;

FIG. 5 is a diagram illustrating a result of a perception experiment in the experimental conditions A and B;

FIG. 6A is a diagram illustrating a luminance of a display panel of FIG. 2 according to a time when the display panel emits a light at a duty ratio of 20%;

FIG. 6B is a diagram illustrating a luminance of the display panel of FIG. 2 according to a time when the display panel emits a light at the duty ratio of 50%;

FIG. 6C is a diagram illustrating a luminance of the display panel of FIG. 2 according to a time when the display panel emits a light at the duty ratio of 100%;

FIG. 7A is a diagram illustrating a waveform of an emission signal according to a time when the display panel of FIG. 2 emits a light at a duty ratio of 20%;

FIG. 7B is a diagram illustrating a waveform of the emission signal according to a time when the display panel of FIG. 2 emits a light at the duty ratio of 50%;

FIG. 7C is a diagram illustrating a waveform of the emission signal according to a time when the display panel of FIG. 2 emits a light at the duty ratio of 100%;

FIG. 8 is a flowchart diagram illustrating aspects of a method of driving the display apparatus of FIG. 1;

FIG. 9A is a diagram illustrating a central viewing area and a peripheral viewing area of the display panel of FIG. 2;

FIG. 9B is a diagram illustrating the central viewing area and the peripheral viewing area of the display panel of FIG. 2;

FIG. 10A is a diagram illustrating the central viewing area and a display block of the display panel of FIG. 2;

FIG. 10B is a diagram illustrating the central viewing area and the display block of the display panel of FIG. 2;

FIG. 11 is a flowchart diagram illustrating a method of driving a display apparatus according to some embodiments of the present disclosure;

FIG. 12A is a diagram illustrating a luminance of a display panel of a display apparatus according to some embodiments of the present disclosure according to a time when the display panel emits a light at a frequency of 60 Hz;

FIG. 12B is a diagram illustrating a luminance of the display panel of FIG. 12A according to a time when the display panel emits a light at the frequency of 120 Hz;

FIG. 13A is a diagram illustrating a waveform of the emission signal according to a time when the display panel of FIG. 12A emits a light at the frequency of 60 Hz;

FIG. 13B is a diagram illustrating a waveform of the emission signal according to a time when the display panel of FIG. 12A emits a light at the frequency of 120 Hz;

FIG. 14 is a flowchart diagram illustrating a method of driving a display apparatus according to some embodiments of the present disclosure;

FIG. 15 is a flowchart diagram illustrating a method of driving a display apparatus according to some embodiments of the present disclosure;

FIG. 16 is a flowchart diagram illustrating a method of driving a display apparatus according to some embodiments of the present disclosure;

FIG. 17 is a flowchart diagram illustrating a method of driving a display apparatus according to some embodiments of the present disclosure;

FIG. 18 is a block diagram illustrating a display apparatus according to some embodiments of the present disclosure;

FIG. 19 is a block diagram illustrating an electronic apparatus according to some embodiments of the present disclosure;

FIG. 20 is a diagram illustrating an example in which the electronic apparatus of FIG. 19 is implemented as a smartphone; and

FIG. 21 is a diagram illustrating an example in which the electronic apparatus of FIG. 19 is implemented as a monitor.

### DETAILED DESCRIPTION

Hereinafter, aspects of some embodiments of the present disclosure will be explained in more detail with reference to the accompanying drawings.

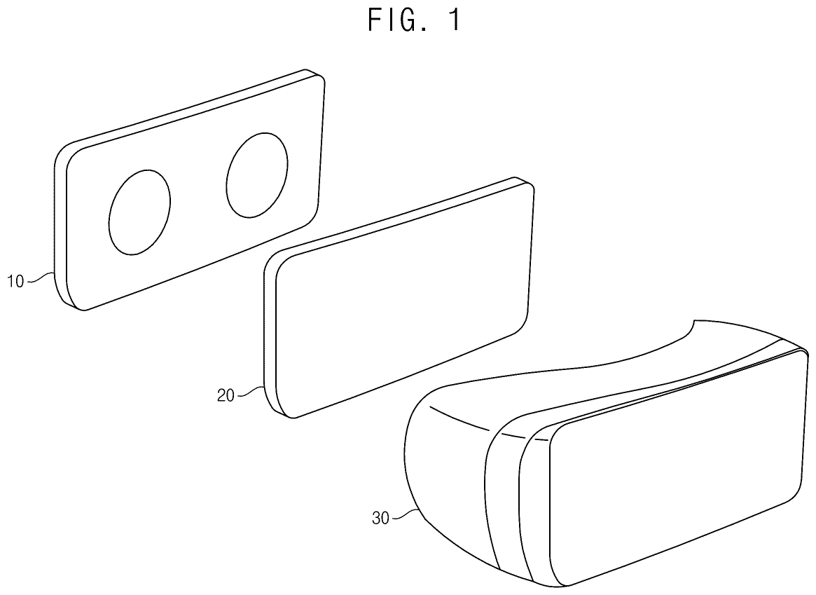

FIG. 1 is a diagram illustrating a display apparatus according to some embodiments of the present disclosure.

Referring to FIG. 1, the display apparatus may include a lens 10, a display module 20 and a housing 30. The display module 20 may be located adjacent to the lens 10. The housing 30 may receive the lens 10 and the display module 20. Although the lens 10 and the display module 20 are received on a first side of the housing 30 in FIG. 1, embodiments according to the present disclosure are not limited thereto.

For example, the lens 10 may be received on a first side of the housing 30 and the display module 20 may be received on a second side of the housing 30 opposite to the first side of the housing 30. When the lens 10 and the display module 20 are received on opposite sides with respect to the housing 30, the housing 30 may have a transmitting portion to transmit a light.

For example, the display apparatus may be a head mounted display apparatus worn on a user's head. According to some embodiments, the head mounted display apparatus may further include a head band to fix the display apparatus to the user's head.

Alternatively, the display apparatus may have a form of smart glasses designed as a shape of glasses.

For example, the display apparatus may be implemented as a virtual reality (VR) display apparatus for supporting a virtual reality.

In addition, the display apparatus may be implemented as an augmented reality (AR) display apparatus for supporting an augmented reality. The AR display apparatus may have a smartphone shape, a smart glasses shape, a head mounted display shape, etc., but embodiments according to the present disclosure are not limited to those shapes.

In addition, the display apparatus may be implemented as a mixed reality (MR) display apparatus for supporting a mixed reality. The MR display apparatus may have a smartphone shape, a smart glasses shape, a head mounted display shape, etc., but embodiments according to the present disclosure are not limited to those shapes.

The display module 20 may include a first display panel. The first display panel may be a left-eye display panel corresponding to a left eye of the user.

The display module 20 may include a second display panel. The second display panel may be a right-eye display panel corresponding to a right eye of the user.

The lens 10 may include a left-eye lens corresponding to the left-eye display panel and a right-eye lens corresponding to the right-eye display panel.

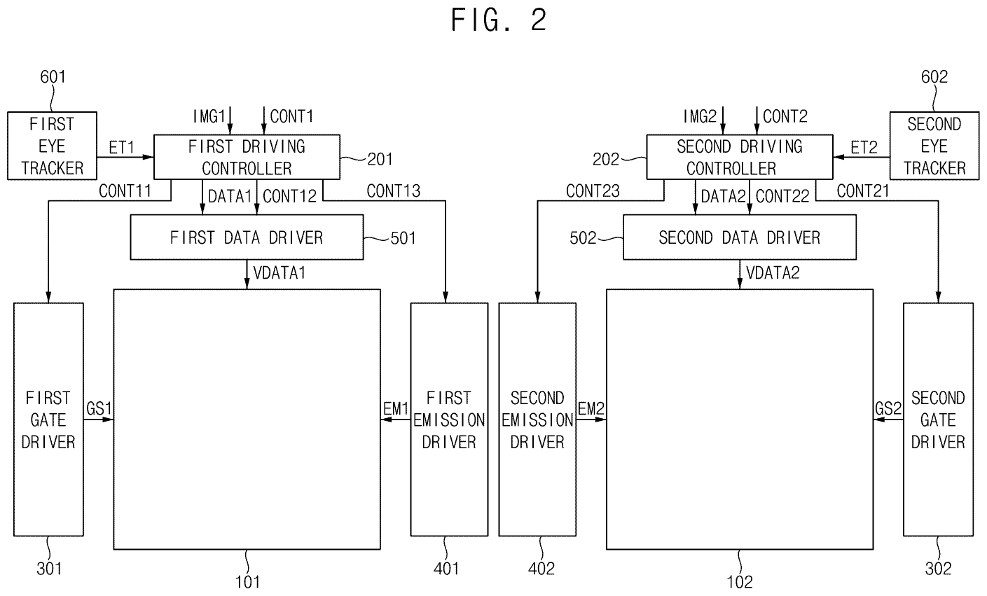

FIG. 2 is a block diagram illustrating the display apparatus of FIG. 1.

Referring to FIGS. 1 and 2, the display apparatus includes a display panel 101, an eye tracker 601 and a display panel driver. The display panel driver drives the display panel 101. The display panel driver includes a driving controller 201, a gate driver 301, an emission driver 401 and a data driver 501.

The display panel 101, the eye tracker 601, the driving controller 201, the gate driver 301, the emission driver 401 and the data driver 501 may be referred to as a first display panel 101, a first eye tracker 601, a first driving controller 201, a first gate driver 301, a first emission driver 401 and a first data driver 501, respectively. For example, the first display panel 101 may be the left-eye display panel corresponding to the left eye of the user.

For example, the driving controller 201 and the data driver 501 may be integrally formed. A driving module including at least the driving controller 201 and the data driver 501 which are integrally formed may be referred to as a timing controller embedded data driver (TED).

The display panel 101 has a display region at which images are displayed and a peripheral region adjacent to the display region.

The display panel 101 includes a plurality of gate lines, a plurality of data lines, a plurality of emission lines and a plurality of pixels electrically connected to the gate lines, the data lines and the emission lines. The gate lines may extend in a first direction, the data lines may extend in a second direction crossing the first direction and the emission lines may extend in the first direction.

The driving controller 201 receives input image data IMG1 and an input control signal CONT1 from an external apparatus (e.g. a host, a set apparatus or an application processor). For example, the input image data IMG1 may include red image data, green image data and blue image data. For example, the input image data IMG1 may include white image data. For example, the input image data IMG1 may include magenta image data, yellow image data and cyan image data. The input control signal CONT1 may include a master clock signal and a data enable signal. The input control signal CONT1 may further include a vertical synchronizing signal and a horizontal synchronizing signal.

The driving controller 201 generates a first control signal CONT11, a second control signal CONT12, a third control signal CONT13 and a data signal DATA1 based on the input image data IMG1 and the input control signal CONT1.

The driving controller 201 generates the first control signal CONT11 for controlling an operation of the gate driver 301 based on the input control signal CONT1, and outputs the first control signal CONT11 to the gate driver 301. The first control signal CONT11 may include a vertical start signal and a gate clock signal.

The driving controller 201 generates the second control signal CONT12 for controlling an operation of the data driver 501 based on the input control signal CONT1, and outputs the second control signal CONT12 to the data driver 501. The second control signal CONT12 may include a horizontal start signal and a load signal.

The driving controller 201 generates the data signal DATA1 based on the input image data IMG1. The driving controller 201 outputs the data signal DATA1 to the data driver 501.

The driving controller 201 generates the third control signal CONT13 for controlling an operation of the emission driver 401 based on the input control signal CONT1, and outputs the third control signal CONT13 to the emission driver 401.

The gate driver 301 generates gate signals GS1 driving the gate lines in response to the first control signal CONT11 received from the driving controller 201. The gate driver 301 outputs the gate signals GS1 to the gate lines. For example, the gate driver 301 may sequentially output the gate signals GS1 to the gate lines. For example, the gate driver 301 may be mounted on the peripheral region of the display panel 101. For example, the gate driver 301 may be integrated on the peripheral region of the display panel 101.

The emission driver 401 generates emission signals EM1 driving the emission lines in response to the third control signal CONT13 received from the driving controller 201. The emission driver 401 outputs the emission signals EM1 to the emission lines. For example, the emission driver 401 may sequentially output the emission signals EM1 to the emission lines. For example, the emission driver 401 may be mounted on the peripheral region of the display panel 101. For example, the emission driver 401 may be integrated on the peripheral region of the display panel 101.

Although the gate driver 301 is located at a first side of the display panel 101 and the emission driver 401 is located at a second side of the display panel 101 opposite to the first side in FIG. 2 for convenience of explanation, embodiments according to the present disclosure are not limited thereto. For example, both of the gate driver 301 and the emission driver 401 may be located at the first side of the display panel 101. For example, both of the gate driver 301 and the emission driver 401 may be located at both sides of the display panel 101. For example, the gate driver 301 and the emission driver 401 may be integrally formed.

The data driver 501 may receive the second control signal CONT12 and the data signal DATA1 from the driving controller 201. The data driver 501 may convert the data signal DATA1 into data voltages VDATA1 having an analog type. The data driver 501 outputs the data voltages VDATA1 to the data lines.

The eye tracker 601 may track a view of the user. For example, the eye tracker 601 may track a view of the left eye of the user. The eye tracker 601 may output a view signal ET1 to the driving controller 201.

In the present embodiments, the display panel driver may determine a central viewing area of the display panel 101 and a peripheral viewing area of the display panel 101 based on the view of the user, drive the central viewing area of the display panel 101 at a first duty ratio and drive the peripheral viewing area of the display panel 101 at a second duty ratio. The first duty ratio is less than the second duty ratio.

The display apparatus includes a second display panel 102, a second eye tracker 602 and a second display panel driver. The second display panel driver drives the second display panel 102. The second display panel driver includes a second driving controller 202, a second gate driver 302, a second emission driver 402 and a second data driver 502.

For example, the second display panel 102 may be the right-eye display panel corresponding to the right eye of the user.

For example, the second driving controller 202 and the second data driver 502 may be integrally formed. A driving module including at least the second driving controller 202 and the second data driver 502 which are integrally formed may be referred to as a second timing controller embedded data driver (TED).

The second display panel 102 has a display region on which an image is displayed and a peripheral region adjacent to the display region.

The second display panel 102 includes a plurality of second gate lines, a plurality of second data lines, a plurality of second emission lines and a plurality of second pixels electrically connected to the second gate lines, the second data lines and the second emission lines. The second gate lines may extend in the first direction, the second data lines may extend in the second direction and the second emission lines may extend in the first direction.

The second driving controller 202 receives second input image data IMG2 and a second input control signal CONT2 from an external apparatus (e.g. a host, a set apparatus or an application processor). For example, the second input image data IMG2 may include red image data, green image data and blue image data. For example, the second input image data IMG2 may include white image data. For example, the second input image data IMG2 may include magenta image data, yellow image data and cyan image data. The second input control signal CONT2 may include a master clock signal and a data enable signal. The second input control signal CONT2 may further include a vertical synchronizing signal and a horizontal synchronizing signal.

The second driving controller 202 generates a 2-1 control signal CONT21, a 2-2 control signal CONT22, a 2-3 control signal CONT23 and a second data signal DATA2 based on the second input image data IMG2 and the second input control signal CONT2.

The second driving controller 202 generates the 2-1 control signal CONT21 for controlling an operation of the second gate driver 302 based on the second input control signal CONT2, and outputs the 2-1 control signal CONT21 to the second gate driver 302. The 2-1 control signal CONT21 may include a second vertical start signal and a second gate clock signal.

The second driving controller 202 generates the 2-2 control signal CONT22 for controlling an operation of the second data driver 502 based on the second input control signal CONT2, and outputs the 2-2 control signal CONT22 to the second data driver 502. The 2-2 control signal CONT22 may include a second horizontal start signal and a second load signal.

The second driving controller 202 generates the second data signal DATA2 based on the second input image data IMG2. The second driving controller 202 outputs the second data signal DATA2 to the second data driver 502.

The second driving controller 202 generates the 2-3 control signal CONT23 for controlling an operation of the second emission driver 402 based on the second input control signal CONT2, and outputs the 2-3 control signal CONT23 to the second emission driver 402.

The second gate driver 302 generates second gate signals GS2 driving the second gate lines in response to the 2-1 control signal CONT21 received from the second driving controller 202. The second gate driver 302 outputs the second gate signals GS2 to the second gate lines. For example, the second gate driver 302 may sequentially output the second gate signals GS2 to the second gate lines. For example, the second gate driver 302 may be mounted on the peripheral region of the second display panel 102. For example, the second gate driver 302 may be integrated on the peripheral region of the second display panel 102.

The second emission driver 402 generates second emission signals EM2 driving the second emission lines in response to the 2-3 control signal CONT23 received from the second driving controller 202. The second emission driver 402 outputs the second emission signals EM2 to the second emission lines. For example, the second emission driver 402 may sequentially output the second emission signals EM2 to the second emission lines. For example, the second emission driver 402 may be mounted on the peripheral region of the second display panel 102. For example, the second emission driver 402 may be integrated on the peripheral region of the second display panel 102.

Although the second gate driver 302 is located at a first side of the second display panel 102 and the second emission driver 402 is located at a second side of the second display panel 102 opposite to the first side in FIG. 2 for convenience of explanation, embodiments according to the present disclosure are not limited thereto. For example, both of the second gate driver 302 and the second emission driver 402 may be located at the first side of the second display panel 102. For example, both of the second gate driver 302 and the second emission driver 402 may be located both sides of the second display panel 102. For example, the second gate driver 302 and the second emission driver 402 may be integrally formed.

The second data driver 502 may receive the 2-2 control signal CONT22 and the second data signal DATA2 from the second driving controller 202. The second data driver 502 may convert the second data signal DATA2 into second data voltages VDATA2 having an analog type. The second data driver 502 outputs the second data voltages VDATA2 to the second data lines.

The second eye tracker 602 may track a second view of the user. For example, the second eye tracker 602 may track a view of the right eye of the user. The second eye tracker 602 may output a second view signal ET2 to the second driving controller 202.

According to some embodiments, the second display panel driver may determine a central viewing area of the second display panel 102 and a peripheral viewing area of the second display panel 102 based on the second view of the user, drive the central viewing area of the second display panel 102 at the first duty ratio and drive the peripheral viewing area of the second display panel 102 at the second duty ratio.

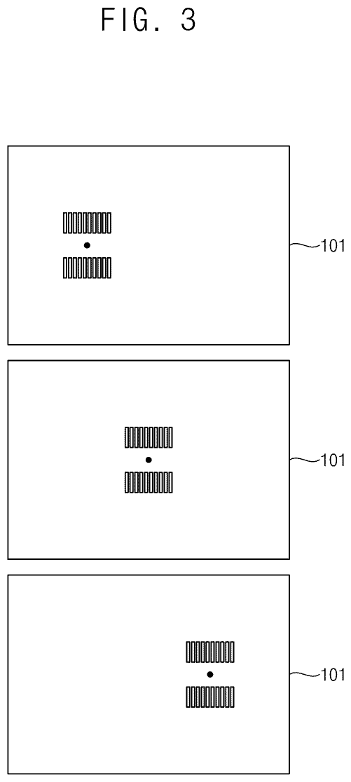

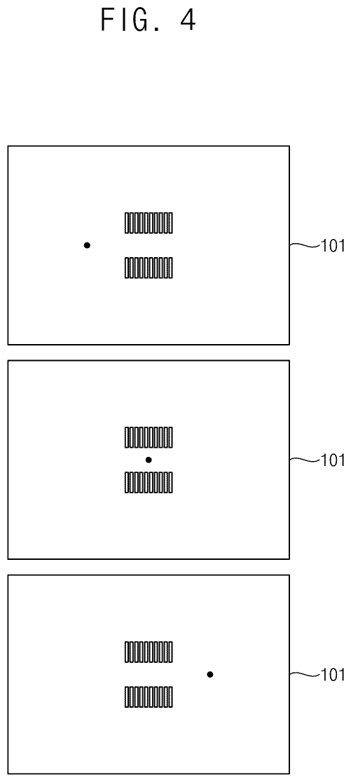

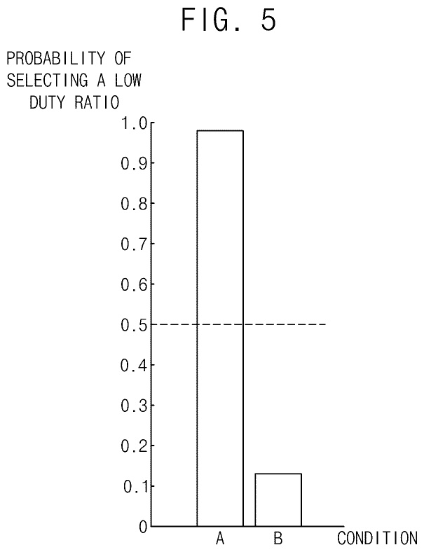

FIG. 3 is a diagram illustrating an experimental condition A. FIG. 4 is a diagram illustrating an experimental condition B. FIG. 5 is a diagram illustrating a result of a perception experiment in the experimental conditions A and B.

The experiments in FIGS. 3 to 5 illustrates that human cognitive characteristics perceive motion blur differently for each duty ratio depending on contents.

In FIGS. 3 and 4, a dot in the display panel 101 represents a gaze position at which an experimenter should gaze and long rectangles in the display panel 101 represent objects displayed on the display panel 101.

FIG. 3 illustrates the experimental condition A. An uppermost portion of FIG. 3 illustrates the gaze position and a position of the objects in a first time, a central portion of FIG. 3 illustrates the gaze position and a position of the objects in a second time subsequent to the first time and a lowermost portion of FIG. 3 illustrates the gaze position and a position of the objects in a third time subsequent to the second time.

In the experimental condition A, the objects in the image move from left to right and the experimenter's viewpoint moves from left to right with the objects. FIG. 5 illustrates the experimenters' response results. In the experimental condition A, the experimenters responded that motion blur was lowest when the display panel 101 emits a light at a low duty ratio. When the objects in the image and the experimenter's viewpoint move together, the motion blur may be low at the low duty ratio.

FIG. 4 illustrates the experimental condition B. An uppermost portion of FIG. 4 illustrates the gaze position and a position of the objects in a first time, a central portion of FIG. 4 illustrates the gaze position and a position of the objects in a second time subsequent to the first time and a lowermost portion of FIG. 4 illustrates the gaze position and a position of the objects in a third time subsequent to the second time.

In the experimental condition B, the objects are fixed in the image but the experimenter's viewpoint moves from left to right. FIG. 5 illustrates the experimenters' response results. In the experimental condition B, the experimenters did not respond that the motion blur was lowest when the display panel 101 emits a light at a low duty ratio but the experimenters responded that the motion blur was lowest when the display panel 101 emits a light at a high duty ratio. When the objects are fixed in the image but the experimenter's viewpoint moves, the motion blur may be low at the high duty ratio.

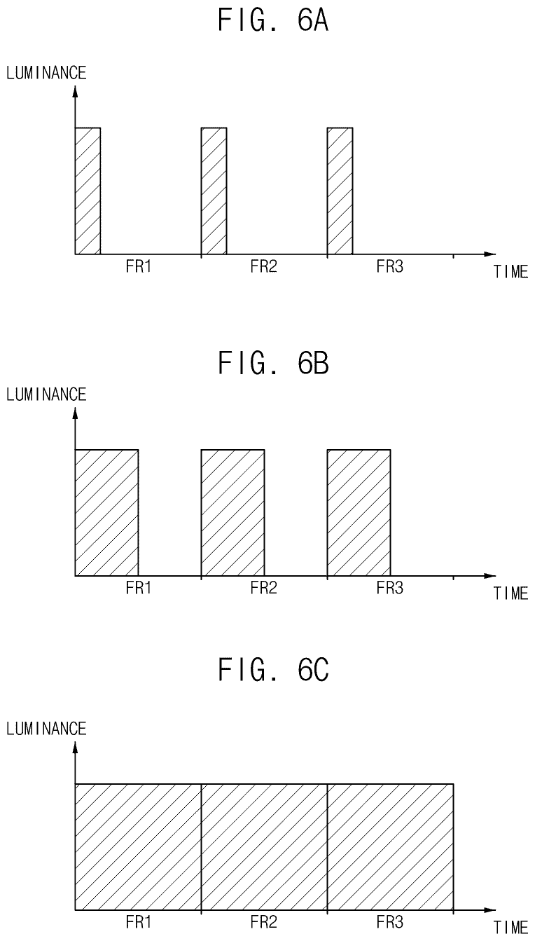

FIG. 6A is a diagram illustrating a luminance of a display panel 101 of FIG. 2 according to a time when the display panel 101 emits a light at a duty ratio of 20%. FIG. 6B is a diagram illustrating a luminance of the display panel 101 of FIG. 2 according to a time when the display panel 101 emits a light at the duty ratio of 50%. FIG. 6C is a diagram illustrating a luminance of the display panel 101 of FIG. 2 according to a time when the display panel 101 emits a light at the duty ratio of 100%.

FIG. 6A represents a case in which the display panel 101 emits a light at the duty ratio of 20%. In FIG. 6A, the display panel 101 may emit a light during 20% of a first frame FR1 and the display panel 101 may not emit a light during 80% of the first frame FR1. In addition, in FIG. 6A, the display panel 101 may emit a light during 20% of a second frame FR2 and the display panel 101 may not emit a light during 80% of the second frame FR2, the display panel 101 may emit a light during 20% of a third frame FR3 and the display panel 101 may not emit a light during 80% of the third frame FR3.

FIG. 6B represents a case in which the display panel 101 emits a light at the duty ratio of 50%. In FIG. 6B, the display panel 101 may emit a light during 50% of a first frame FR1 and the display panel 101 may not emit a light during 50% of the first frame FR1. In addition, in FIG. 6B, the display panel 101 may emit a light during 50% of a second frame FR2 and the display panel 101 may not emit a light during 50% of the second frame FR2, the display panel 101 may emit a light during 50% of a third frame FR3 and the display panel 101 may not emit a light during 50% of the third frame FR3.

FIG. 6C represents a case in which the display panel 101 emits a light at the duty ratio of 100%. In FIG. 6C, the display panel 101 may emit a light during 100% of a first frame FR1, the display panel 101 may emit a light during 100% of a second frame FR2 and the display panel 101 may emit a light during 100% of a third frame FR3.

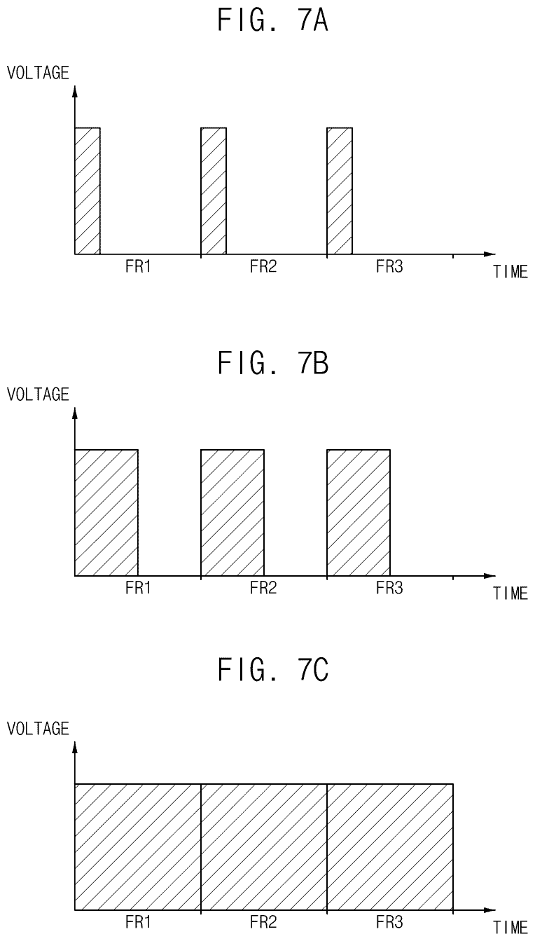

FIG. 7A is a diagram illustrating a waveform of an emission signal according to a time when the display panel 101 of FIG. 2 emits a light at a duty ratio of 20%. FIG. 7B is a diagram illustrating a waveform of the emission signal according to a time when the display panel 101 of FIG. 2 emits a light at the duty ratio of 50%. FIG. 7C is a diagram illustrating a waveform of the emission signal according to a time when the display panel 101 of FIG. 2 emits a light at the duty ratio of 100%.

As shown in FIG. 7A, the emission signal having a duty ratio of 20% may be applied to the display panel 101 such that the display panel 101 emits a light at the duty ratio of 20%.

As shown in FIG. 7B, the emission signal having a duty ratio of 50% may be applied to the display panel 101 such that the display panel 101 emits a light at the duty ratio of 50%.

As shown in FIG. 7C, the emission signal having a duty ratio of 100% may be applied to the display panel 101 such that the display panel 101 emits a light at the duty ratio of 100%.

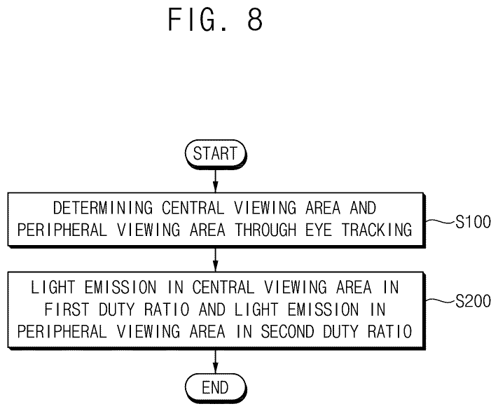

FIG. 8 is a flowchart diagram illustrating aspects of a method of driving the display apparatus of FIG. 1. Although FIG. 8 illustrates various operations in a method of driving a display apparatus, embodiments according to the present disclosure are not limited thereto, and according to various embodiments, the method may include additional operations or fewer operations, or the order of operations may vary, unless otherwise stated or implied, without departing from the spirit and scope of embodiments according to the present disclosure.

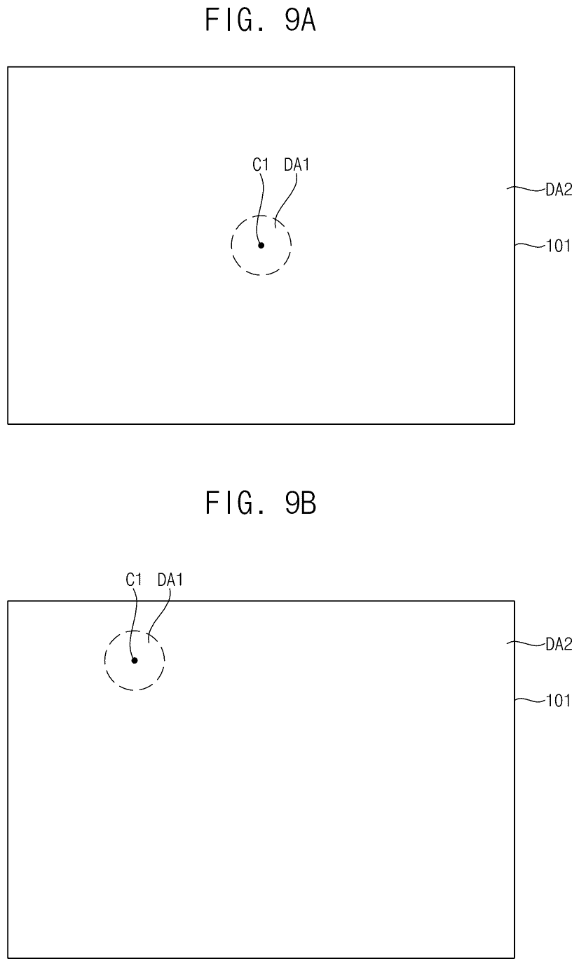

FIG. 9A is a diagram illustrating a central viewing area DA1 and a peripheral viewing area DA2 of the display panel 101 of FIG. 2. FIG. 9B is a diagram illustrating the central viewing area DA1 and the peripheral viewing area DA2 of the display panel 101 of FIG. 2.

Referring to FIGS. 1 to 9B, the eye tracker 601 may track the view of the user. The display panel driver may determine the central viewing area DA1 of the display panel 101 and the peripheral viewing area DA2 of the display panel 101 based on the view of the user (operation S100). The central viewing area DA1 may include a central point C1 of the viewpoint of the user. For example, the central viewing area DA1 may be determined to have a visual angle of 12 degrees from the center point C1 of the viewpoint of the user.

The display panel driver may drive the central viewing area DA1 of the display panel 101 at the first duty ratio and drive the peripheral viewing area DA2 of the display panel 101 at the second duty ratio (operation S200). Herein, the first duty ratio may be less than the second duty ratio. For example, the first duty ratio may be less than 100% and the second duty ratio may be 100%. For example, the first duty ratio may be 50% and the second duty ratio may be 100%.

In the experimental condition A of FIG. 3, the objects in the image and the experimenter's viewpoint move together, and an area including the objects (an area where objects and viewpoint move together) may correspond to the central viewing area DA1. For example, when the central viewing area DA1 emits a light at a relatively low duty ratio, the perception degree of the motion blur may be relatively reduced.

In the experimental condition B of FIG. 4, the objects are fixed in the image but the experimenter's viewpoint moves (herein, the fixed objects may mean fixed backgrounds), and an area including the fixed objects (an area where the backgrounds are fixed but the viewpoint moves) may correspond to the peripheral viewing area DA2. For example, when the peripheral viewing area DA2 emits a light at a relatively high duty ratio, the perception of the motion blur may be relatively reduced.

To drive the central viewing area DA1 of the display panel 101 at the first duty ratio and the peripheral viewing area DA2 of the display panel 101 at the second duty ratio, the emission driver 401 may apply the emission signal having the first duty ratio to the central viewing area DA1 and the emission signal having the second duty ratio to the peripheral viewing area DA2.

For example, the central viewing area DA1 is located in a central portion of the display panel 101 in FIG. 9A. For example, the central viewing area DA1 is located in an upper left portion of the display panel 101 in FIG. 9B.

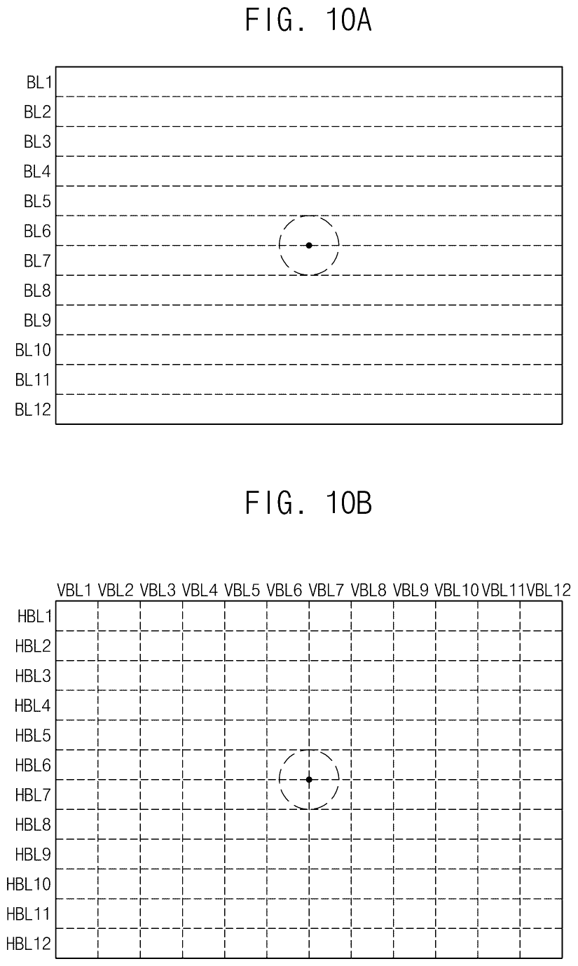

FIG. 10A is a diagram illustrating the central viewing area DA1 and a display block BL1 to BL12 of the display panel 101 of FIG. 2.

As shown in FIG. 10A, the display panel 101 may include plural display blocks BL1 to BL12 extending in a first direction and arranged in a second direction. The display panel driver may drive display blocks (BL6 and BL7 in FIG. 10A) including the central viewing area DA1 of the display panel 101 among the display blocks BL1 to BL12 at the first duty ratio and display blocks (BL1 to BL5 and BL8 to BL12 in FIG. 10A) not including the central viewing area DA1 of the display panel 101 among the display blocks BL1 to BL12 at the second duty ratio.

The emission signal may be applied to the display panel 101 along the first direction (e.g. a horizontal direction) so that the duty ratio of the emission signal may be controlled in a unit of the display blocks BL1 to BL12 which extend in the first direction (e.g. the horizontal direction).

Although the display panel 101 includes twelve display blocks in FIG. 10A, embodiments according to the present disclosure are not limited to the number of the display blocks.

FIG. 10B is a diagram illustrating the central viewing area DA1 and the display block VBL1 to VBL12 and HBL1 to HBL12 of the display panel 101 of FIG. 2.

As shown in FIG. 10B, the display panel 101 may include first display blocks HBL1 to HBL12 extending in a first direction and arranged in a second direction and second display blocks VBL1 to VBL12 extending in the second direction and arranged in the first direction. The display panel driver may drive an area corresponding to an intersection of the first display blocks (HBL6 and HBL7 in FIG. 10B) including the central viewing area DA1 of the display panel 101 among the first display blocks HBL1 to HBL12 and the second display blocks (VBL6 and VBL7 in FIG. 10B) including the central viewing area DA1 of the display panel 101 among the second display blocks VBL1 to VBL12 at the first duty ratio. The display panel driver may drive an area not corresponding to the intersection at the second duty ratio.

According to some embodiments, the emission signal may be applied to the display panel 101 in a unit of rectangular blocks (144 blocks in FIG. 10B) formed at overlapped areas of the first display blocks HBL1 to HBL12 and the second display blocks VBL1 to VBL12. The duty ratio of the emission signal may be controlled in a unit of the rectangular blocks.

Although the display panel 101 includes twelve first display blocks and twelve second display blocks in FIG. 10B, embodiments according to the present disclosure are not limited to the number of the first display blocks and the number of the second display blocks.

According to some embodiments, the central viewing area DA1 of the display panel 101 and the peripheral viewing area DA2 of the display panel 101 may emit light at different duty ratios so that a perception degree of motion blur of the display panel 101 may be relatively reduced.

The perception degree of the motion blur of the display panel 101 is relatively reduced so that the display quality may be enhanced and the dizziness may be relatively reduced.

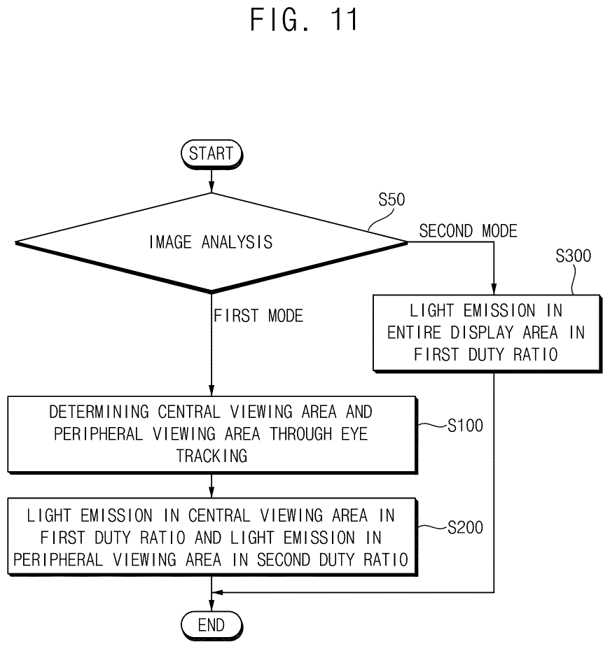

FIG. 11 is a flowchart diagram illustrating aspects of a method of driving a display apparatus according to some embodiments of the present disclosure. Although FIG. 11 illustrates various operations in a method of driving a display apparatus, embodiments according to the present disclosure are not limited thereto, and according to various embodiments, the method may include additional operations or fewer operations, or the order of operations may vary, unless otherwise stated or implied, without departing from the spirit and scope of embodiments according to the present disclosure.

The display apparatus according to the present embodiments is the same (or substantially the same) as the display apparatus of the previous embodiments explained with reference to FIGS. 1 to 10B except that the display panel driver analyzes input image data to determine a first mode and a second mode and a duty ratio of a display area is controlled according to the first mode and the second mode. Thus, the same reference numerals will be used to refer to the same or like parts as those described in the previous embodiments of FIGS. 1 to 10B and some repetitive explanation concerning the above elements may be omitted.

Referring to FIGS. 1 to 7C and FIGS. 9A to 11, the display panel driver may analyze the input image data IMG1 to determine a first mode and a second mode (operation S50).

In the first mode, backgrounds of an image are fixed and an object moves in the backgrounds. In the second mode, the backgrounds of the image change.

In the first mode, the backgrounds of the image are fixed and the object moves in the backgrounds and a viewpoint of the user may naturally follow the object. In this case, a central viewing area DA1 adjacent to the object may correspond to the experimental condition A of FIG. 3 in which the object in the image and the viewpoint of the user move together. In contrast, a peripheral viewing area DA2 not adjacent to the object may correspond to the experimental condition B of FIG. 4 in which the object is fixed in the image but the viewpoint of the user moves (herein, the fixed object may mean a fixed background).

Accordingly, for the first mode, the display panel driver may determine the central viewing area DA1 of the display panel 101 and the peripheral viewing area DA2 of the display panel 101 based on the view of the user (operation S100), drive the central viewing area DA1 of the display panel 101 at the first duty ratio and drive the peripheral viewing area DA2 of the display panel 101 at the second duty ratio (operation S200).

In contrast, the second mode may mean a case in which an entire image changes. In the second mode, the entire image changes so that the object moving with the viewpoint of the user and the background fixed regardless of the viewpoint of the user may not be distinguished. Thus, in the second mode, an entire display area of the display panel 101 may be driven at the same duty ratio (operation S300). For example, in the second mode, the entire display area of the display panel 101 may be driven at the first duty ratio.

According to some embodiments, the central viewing area DA1 of the display panel 101 and the peripheral viewing area DA2 of the display panel 101 may emit light at different duty ratios so that a perception degree of motion blur of the display panel 101 may be relatively reduced.

The perception degree of the motion blur of the display panel 101 is relatively reduced so that the display quality may be enhanced and the dizziness may be relatively reduced.

In the second mode, the entire display area of the display panel 101 is driven at the first duty ratio so that the power consumption may be relatively reduced.

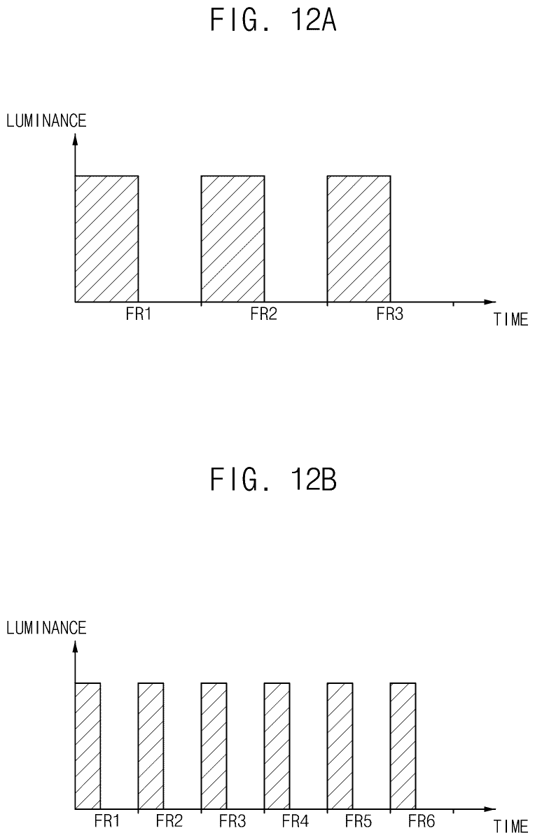

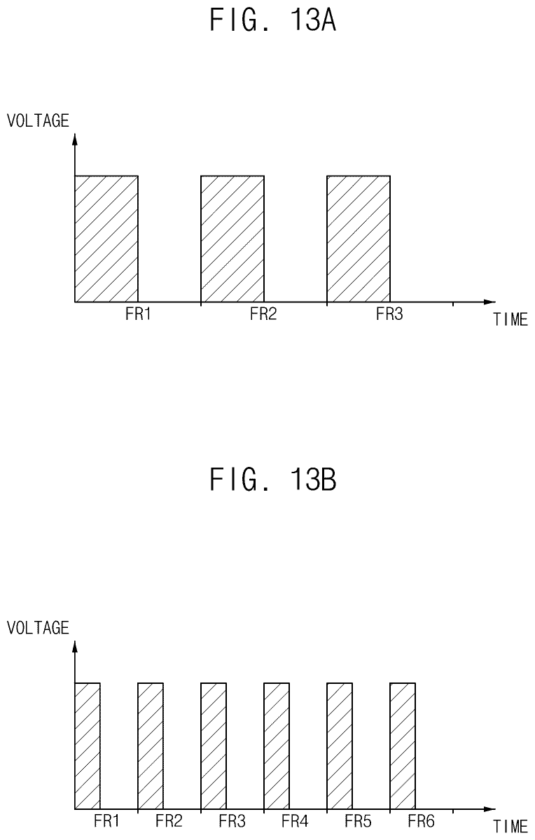

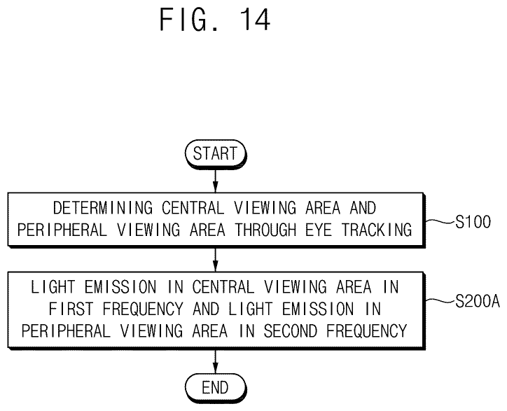

FIG. 12A is a diagram illustrating a luminance of a display panel 101 of a display apparatus according to some embodiments of the present disclosure according to a time when the display panel 101 emits a light at a frequency of 60 Hz. FIG. 12B is a diagram illustrating a luminance of the display panel 101 of FIG. 12A according to a time when the display panel 101 emits a light at the frequency of 120 Hz. FIG. 13A is a diagram illustrating a waveform of the emission signal according to a time when the display panel 101 of FIG. 12A emits a light at the frequency of 60 Hz. FIG. 13B is a diagram illustrating a waveform of the emission signal according to a time when the display panel 101 of FIG. 12A emits a light at the frequency of 120 Hz. FIG. 14 is a flowchart diagram illustrating aspects of a method of driving a display apparatus according to some embodiments of the present disclosure. Although FIG. 14 illustrates various operations in a method of driving a display apparatus, embodiments according to the present disclosure are not limited thereto, and according to various embodiments, the method may include additional operations or fewer operations, or the order of operations may vary, unless otherwise stated or implied, without departing from the spirit and scope of embodiments according to the present disclosure.

The display apparatus according to the present embodiments is the same (or substantially the same) as the display apparatus of the previous embodiments explained referring to FIGS. 1 to 10B except that a central viewing area of the display panel 101 and a peripheral viewing area of the display panel 101 are driven at different frequencies. Thus, the same reference numerals will be used to refer to the same or like parts as those described in the previous embodiments of FIGS. 1 to 10B and some repetitive explanation concerning the above elements may be omitted.

Referring to FIGS. 1, 2, 9A to 10B and 12A to 14, the eye tracker 601 may track a view of the user. The display panel driver may determine the central viewing area DA1 of the display panel 101 and the peripheral viewing area DA2 of the display panel 101 based on the view of the user (operation S100). The central viewing area DA1 may include a central point C1 of the viewpoint of the user. For example, the central viewing area DA1 may be determined to have a visual angle of 12 degrees from the center point C1 of the viewpoint of the user.

The display panel driver may drive the central viewing area DA1 of the display panel 101 at a first frequency and drive the peripheral viewing area DA2 of the display panel 101 at a second frequency (operation S200A). Herein, the first frequency may be greater than the second frequency. For example, the first frequency may be 120 Hz and the second frequency may be 60 Hz.

In FIG. 12A, the display panel 101 may emit a light at a relatively low frequency (e.g. 60 Hz). In FIG. 12B, the display panel 101 may emit a light at a relatively high frequency (e.g. 120 Hz). For example, the duty ratio may be 50% in FIGS. 12A and 12B.

As shown in FIG. 13A, to emit a light on the display panel 101 at the relatively low frequency (e.g. 60 Hz), the emission signal having the relatively low frequency (e.g. 60 Hz) may be applied to the display panel 101.

As shown in FIG. 13B, to emit a light on the display panel 101 at the relatively high frequency (e.g. 120 Hz), the emission signal having the relatively high frequency (e.g. 120 Hz) may be applied to the display panel 101.

When the central viewing area DA1, where the object in the image and the viewpoint of the user move together, is driven at the relatively high frequency, the perception degree of the motion blur may be relatively reduced.

In contrast, although the peripheral viewing area DA2, where the object is fixed in the image but the viewpoint of the user moves (herein, the fixed object may mean a fixed background), is driven at the relatively low frequency, the motion blur may not be well perceived to the user.

To drive the central viewing area DA1 of the display panel 101 at the first frequency and the peripheral viewing area DA2 of the display panel 101 at the second frequency, the emission driver 401 may apply the emission signal having the first frequency to the central viewing area DA1 and the emission signal having the second frequency to the peripheral viewing area DA2.

Similarly to FIG. 10A, the emission signal may be applied to the display panel 101 along the first direction (e.g. a horizontal direction) so that the frequency of the emission signal may be controlled in a unit of the display blocks BL1 to BL12 which extend in the first direction (e.g. the horizontal direction).

Similarly to FIG. 10B, the emission signal may be applied to the display panel 101 in a unit of rectangular blocks (144 blocks in FIG. 10B) formed at overlapped areas of the first display blocks HBL1 to HBL12 and the second display blocks VBL1 to VBL12. The frequency of the emission signal may be controlled in a unit of the rectangular blocks.

The display apparatus may further include a second display panel 102 located adjacent to the first display panel 101, a second eye tracker 602 tracking a second view of the user and a second display panel driver determining a central viewing area of the second display panel 102 and a peripheral viewing area of the second display panel 102 based on the second view of the user, driving the central viewing area of the second display panel 102 at the first frequency and driving the peripheral viewing area of the second display panel 102 at the second frequency.

According to some embodiments, the central viewing area DA1 of the display panel 101 and the peripheral viewing area DA2 of the display panel 101 may emit light at different frequencies so that a perception degree of motion blur of the display panel 101 may be relatively reduced.

The perception degree of the motion blur of the display panel 101 is relatively reduced so that the display quality may be enhanced and the dizziness may be relatively reduced.

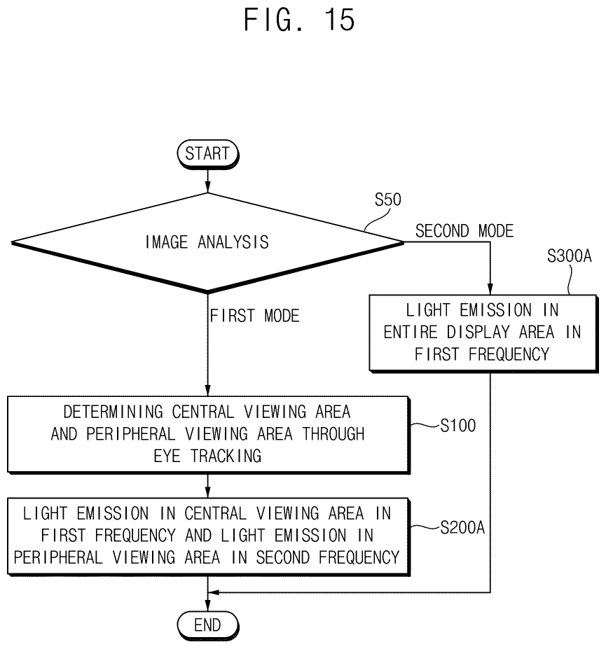

FIG. 15 is a flowchart diagram illustrating aspects of a method of driving a display apparatus according to some embodiments of the present disclosure. Although FIG. 15 illustrates various operations in a method of driving a display apparatus, embodiments according to the present disclosure are not limited thereto, and according to various embodiments, the method may include additional operations or fewer operations, or the order of operations may vary, unless otherwise stated or implied, without departing from the spirit and scope of embodiments according to the present disclosure.

The display apparatus according to the present embodiments is the same (or substantially the same) as the display apparatus of the previous embodiments explained referring to FIGS. 12A to 14 except that the display panel driver analyzes input image data to determine a first mode and a second mode and a frequency of a display area is controlled according to the first mode and the second mode. Thus, the same reference numerals will be used to refer to the same or like parts as those described in the previous embodiments of FIGS. 12A to 14 and some repetitive explanation concerning the above elements may be omitted.

Referring to FIGS. 1, 2, 9A to 10B, 12A to 13B and 15, the display panel driver may analyze the input image data IMG1 to determine a first mode and a second mode (operation S50).

In the first mode, backgrounds of an image are fixed and an object moves in the backgrounds. In the second mode, the backgrounds of the image changes.

In the first mode, the backgrounds of the image are fixed and the object moves in the backgrounds and a viewpoint of the user may naturally follow the object. In this case, a central viewing area DA1 adjacent to the object may correspond to the experimental condition A of FIG. 3 in which the object in the image and the viewpoint of the user move together. In contrast, a peripheral viewing area DA2 not adjacent to the object may correspond to the experimental condition B of FIG. 4 in which the object is fixed in the image but the viewpoint of the user moves (herein, the fixed object may mean a fixed background).

Accordingly, for the first mode, the display panel driver may determine the central viewing area DA1 of the display panel 101 and the peripheral viewing area DA2 of the display panel 101 based on the view of the user (operation S100), drive the central viewing area DA1 of the display panel 101 at the first frequency and drive the peripheral viewing area DA2 of the display panel 101 at the second frequency (operation S200A). Herein, the first frequency may be greater than the second frequency.

In contrast, the second mode may mean a case in which an entire image changes. In the second mode, the entire image changes so that the object moving with the viewpoint of the user and the background fixed regardless of the viewpoint of the user may not be distinguished. Thus, in the second mode, an entire display area of the display panel 101 may be driven at the same frequency (operation S300A). For example, in the second mode, the entire display area of the display panel 101 may be driven at one of the first frequency and the second frequency. For example, in the second mode, the entire display area of the display panel 101 may be driven at the second frequency (the relatively low frequency).

According to some embodiments, the central viewing area DA1 of the display panel 101 and the peripheral viewing area DA2 of the display panel 101 may emit light at different frequencies so that a perception degree of motion blur of the display panel 101 may be relatively reduced.

The perception degree of the motion blur of the display panel 101 is relatively reduced so that the display quality may be enhanced and the dizziness may be relatively reduced.

In the second mode, the entire display area of the display panel 101 is driven at the second frequency so that the power consumption may be relatively reduced.

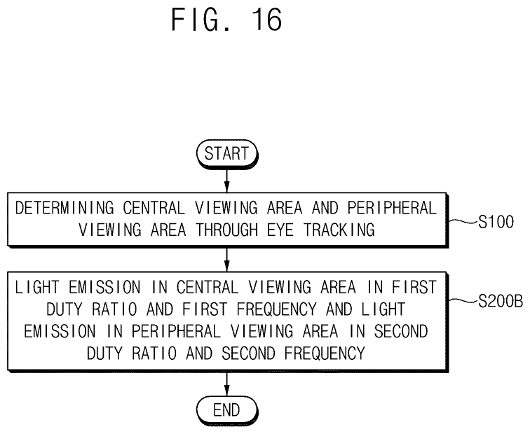

FIG. 16 is a flowchart diagram illustrating a method of driving a display apparatus according to some embodiments of the present disclosure. Although FIG. 16 illustrates various operations in a method of driving a display apparatus, embodiments according to the present disclosure are not limited thereto, and according to various embodiments, the method may include additional operations or fewer operations, or the order of operations may vary, unless otherwise stated or implied, without departing from the spirit and scope of embodiments according to the present disclosure.

The display apparatus according to the present embodiments is the same (or substantially the same) as the display apparatus of the previous embodiments explained referring to FIGS. 1 to 10B except that a central viewing area of the display panel 101 and a peripheral viewing area of the display panel 101 are driven at different duty ratios or different frequencies. Thus, the same reference numerals will be used to refer to the same or like parts as those described in the previous embodiments of FIGS. 1 to 10B and some repetitive explanation concerning the above elements may be omitted.

Referring to FIGS. 1, 2, 9A to 10B, 12A to 13B and 16, the eye tracker 601 may track a view of the user. The display panel driver may determine the central viewing area DA1 of the display panel 101 and the peripheral viewing area DA2 of the display panel 101 based on the view of the user (operation S100). The central viewing area DA1 may include a central point C1 of the viewpoint of the user. For example, the central viewing area DA1 may be determined to have a visual angle of 12 degrees from the center point C1 of the viewpoint of the user.

The display panel driver may drive the central viewing area DA1 of the display panel 101 at a first duty ratio and a first frequency and drive the peripheral viewing area DA2 of the display panel 101 at a second duty ratio and a second frequency (operation S200B). Herein, the first duty ratio may be different from the second duty ratio or the first frequency may be different from the second frequency.

For example, the first duty ratio may be less than the second duty ratio and the first frequency may be the same (or substantially the same) as the second frequency. For example, the first duty ratio may be less than 100% and the second duty ratio may be 100%. For example, the first duty ratio may be 50% and the second duty ration may be 100%.

For example, the first duty ratio may be the same (or substantially the same) as the second duty ratio and the first frequency may be greater than the second frequency. For example, the first frequency may be 120 Hz and the second frequency may be 60 Hz.

For example, the first duty ratio may be less than the second duty ratio and the first frequency may be greater than the second frequency.

When the central viewing area DA1, where the object in the image and the viewpoint of the user move together, is driven at the relatively low duty ratio or the relatively high frequency, the perception degree of the motion blur may be relatively reduced.

In contrast, although the peripheral viewing area DA2, where the object is fixed in the image but the viewpoint of the user moves (herein, the fixed object may mean a fixed background), is driven at the relatively high duty ratio, the motion blur may not be well perceived to the user.

In addition, although the peripheral viewing area DA2, where the object is fixed in the image but the viewpoint of the user moves (herein, the fixed object may mean a fixed background), is driven at the relatively low frequency, the motion blur may not be well perceived to the user.

To drive the central viewing area DA1 of the display panel 101 at the first duty ratio and the first frequency and the peripheral viewing area DA2 of the display panel 101 at the second duty ratio and the second frequency, the emission driver 401 may apply the emission signal having the first duty ratio and the first frequency to the central viewing area DA1 and the emission signal having the second duty ratio and the second frequency to the peripheral viewing area DA2.

The display apparatus may further include a second display panel 102 located adjacent to the first display panel 101, a second eye tracker 602 tracking a second view of the user and a second display panel driver determining a central viewing area of the second display panel 102 and a peripheral viewing area of the second display panel 102 based on the second view of the user, driving the central viewing area of the second display panel 102 at the first duty ratio and the first frequency and driving the peripheral viewing area of the second display panel 102 at the second duty ratio and the second frequency.

According to some embodiments, the central viewing area DA1 of the display panel 101 and the peripheral viewing area DA2 of the display panel 101 may emit light at the different duty ratios or the different frequencies so that a perception degree of motion blur of the display panel 101 may be relatively reduced.

The perception degree of the motion blur of the display panel 101 is relatively reduced so that the display quality may be enhanced and the dizziness may be relatively reduced.

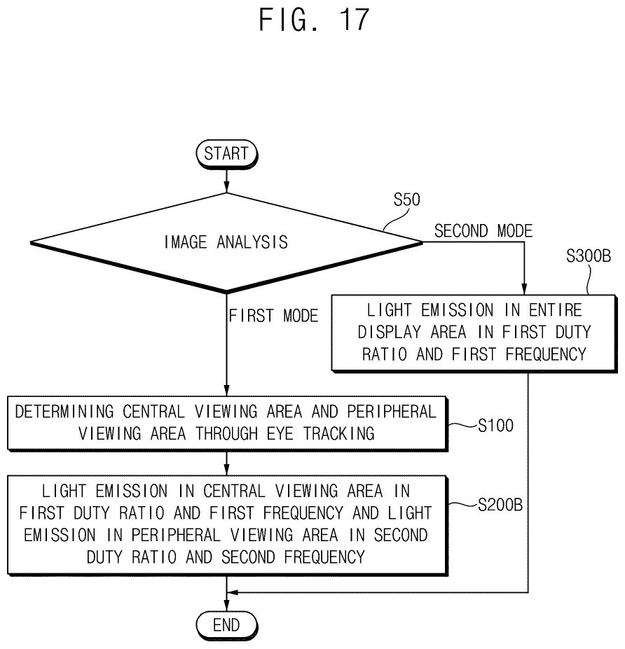

FIG. 17 is a flowchart diagram illustrating aspects of a method of driving a display apparatus according to some embodiments of the present disclosure. Although FIG. 17 illustrates various operations in a method of driving a display apparatus, embodiments according to the present disclosure are not limited thereto, and according to various embodiments, the method may include additional operations or fewer operations, or the order of operations may vary, unless otherwise stated or implied, without departing from the spirit and scope of embodiments according to the present disclosure.

The display apparatus according to the present embodiments is the same (or substantially the same) as the display apparatus of the previous embodiments explained referring to FIG. 16 except that the display panel driver analyzes input image data to determine a first mode and a second mode and a duty ratio and a frequency of a display area is controlled according to the first mode and the second mode. Thus, the same reference numerals will be used to refer to the same or like parts as those described in the previous embodiments of FIG. 16 and some repetitive explanation concerning the above elements may be omitted.

Referring to FIGS. 1, 2, 9A to 10B, 12A to 13B and 17, the display panel driver may analyze the input image data IMG1 to determine a first mode and a second mode (operation S50).

In the first mode, backgrounds of an image are fixed and an object moves in the backgrounds. In the second mode, the backgrounds of the image changes.

In the first mode, the backgrounds of the image are fixed and the object moves in the backgrounds and a viewpoint of the user may naturally follow the object. In this case, a central viewing area DA1 adjacent to the object may correspond to the experimental condition A of FIG. 3 in which the object in the image and the viewpoint of the user move together. In contrast, a peripheral viewing area DA2 not adjacent to the object may correspond to the experimental condition B of FIG. 4 in which the object is fixed in the image but the viewpoint of the user moves (herein, the fixed object may mean a fixed background).

Accordingly, for the first mode, the display panel driver may determine the central viewing area DA1 of the display panel 101 and the peripheral viewing area DA2 of the display panel 101 based on the view of the user (operation S100), drive the central viewing area DA1 of the display panel 101 at the first duty ratio and the first frequency and drive the peripheral viewing area DA2 of the display panel 101 at the second duty ratio and the second frequency (operation S200B). Herein, the first duty ratio may be different from the second duty ratio or the first frequency may be different from the second frequency. For example, the first duty ratio may be less than the second duty ratio and the first frequency may be the same (or substantially the same) as the second frequency. For example, the first duty ratio may be the same (or substantially the same) as the second duty ratio and the first frequency may be greater than the second frequency. For example, the first duty ratio may be less than the second duty ratio and the first frequency may be greater than the second frequency.

In contrast, the second mode may mean a case in which an entire image changes. In the second mode, the entire image changes so that the object moving with the viewpoint of the user and the background fixed regardless of the viewpoint of the user may not be distinguished. Thus, in the second mode, an entire display area of the display panel 101 may be driven at the same duty ratio and the same frequency (operation S300B). For example, in the second mode, the entire display area of the display panel 101 may be driven at the first duty ratio. For example, in the second mode, the entire display area of the display panel 101 may be driven at the second frequency (the relatively low frequency).

According to some embodiments, the central viewing area DA1 of the display panel 101 and the peripheral viewing area DA2 of the display panel 101 may emit light at different duty ratios or different frequencies so that a perception degree of motion blur of the display panel 101 may be relatively reduced.

The perception degree of the motion blur of the display panel 101 is relatively reduced so that the display quality may be enhanced and the dizziness may be relatively reduced.

In the second mode, the entire display area of the display panel 101 is driven at the first duty ratio and the second frequency so that the power consumption may be relatively reduced.

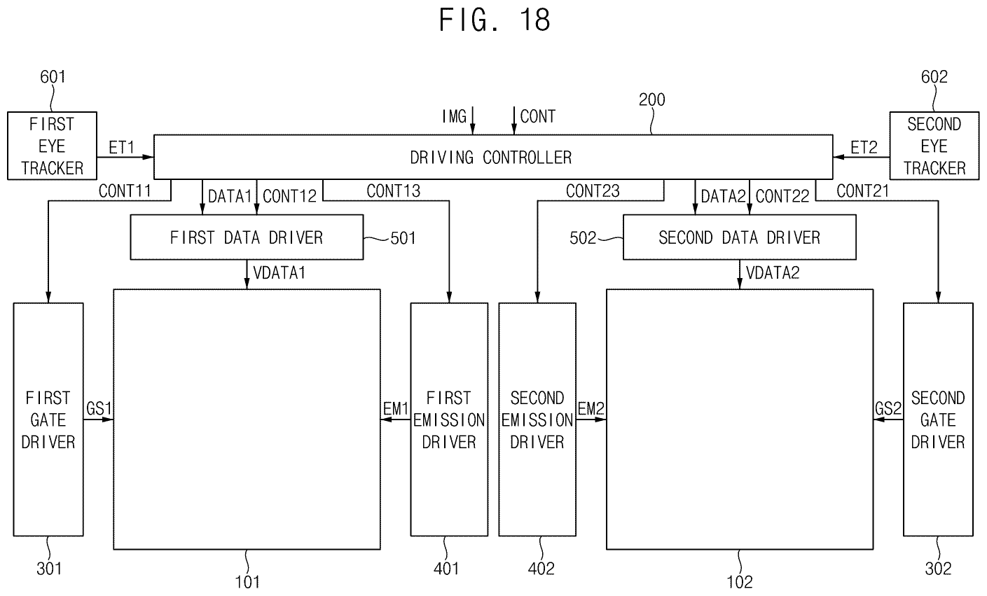

FIG. 18 is a block diagram illustrating a display apparatus according to some embodiments of the present disclosure.

The display apparatus according to the present embodiments is the same (or substantially the same) as the display apparatus of the previous embodiments explained referring to FIGS. 1 to 10B except that the first driving controller and the second driving controller are integrally formed. Thus, the same reference numerals will be used to refer to the same or like parts as those described in the previous embodiments of FIGS. 1 to 10B and some repetitive explanation concerning the above elements may be omitted.

Referring to FIGS. 1, 3 to 10B and 18, the display panel driver may include a gate driver 301 outputting a gate signal GS1 to the display panel 101, a data driver 501 outputting a data voltage VDATA1 to the display panel 101 and an emission driver 401 outputting an emission signal EM1 to the display panel 101.

According to some embodiments, the display panel 101, the eye tracker 601, the gate driver 301, the emission driver 401 and the data driver 501 may be referred to as a first display panel 101, a first eye tracker 601, a first gate driver 301, a first emission driver 401 and a first data driver 501, respectively.

The second display panel driver may include a second gate driver 302 outputting a second gate signal GS2 to the second display panel 102, a second data driver 502 outputting a second data voltage VDATA2 to the second display panel 102 and a second emission driver 402 outputting a second emission signal EM2 to the second display panel 102.

The display panel driver may further include a driving controller 200 controlling the gate driver 301, the data driver 501, the emission driver 401, the second gate driver 302, the second data driver 502 and the second emission driver 402. The driving controller 200 may receive input image data IMG and an input control signal CONT from an external apparatus.

The first eye tracker 601 may output a first view signal ET1 to the driving controller 200. The second eye tracker 602 may output a second view signal ET2 to the driving controller 200.

According to some embodiments, the central viewing area DA1 of the display panel 101 and the peripheral viewing area DA2 of the display panel 101 may emit light at different duty ratios so that a perception degree of motion blur of the display panel 101 may be relatively reduced.

The perception degree of the motion blur of the display panel 101 is relatively reduced so that the display quality may be enhanced and the dizziness may be relatively reduced.

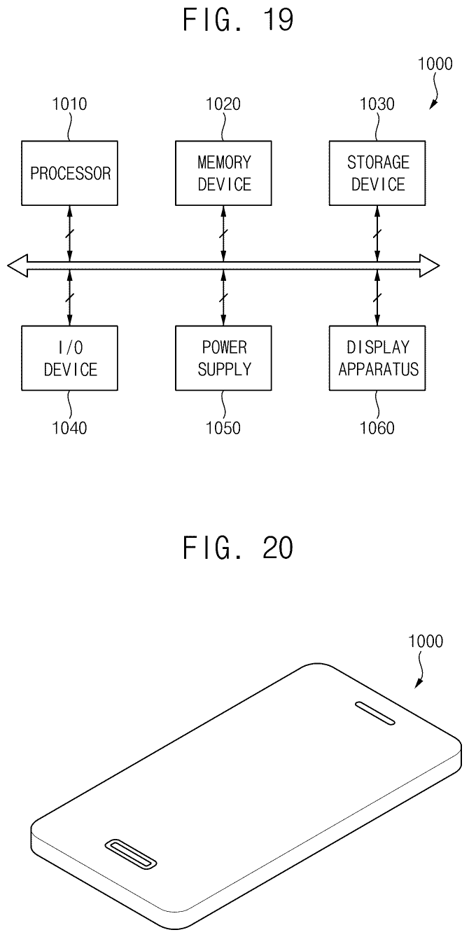

FIG. 19 is a block diagram illustrating an electronic apparatus 1000 according to some embodiments of the present disclosure. FIG. 20 is a diagram illustrating an example in which the electronic apparatus 1000 of FIG. 19 is implemented as a smartphone.

Embodiments according to the present disclosure may not be limited to the display apparatus including the first display panel and the second display panel. Alternatively, the display apparatus may include a single display panel.

Referring to FIGS. 19 and 20, the electronic apparatus 1000 may include a processor 1010, a memory device 1020, a storage device 1030, an input/output (I/O) device 1040, a power supply 1050, and a display apparatus 1060. In addition, the electronic apparatus 1000 may further include a plurality of ports for communicating with a video card, a sound card, a memory card, a universal serial bus (USB) device, other electronic apparatuses, etc.

According to some embodiments, as illustrated in FIG. 20, the electronic apparatus 1000 may be implemented as a smartphone. However, the electronic apparatus 1000 is not limited thereto. For example, the electronic apparatus 1000 may be implemented as a television, a monitor, a cellular phone, a video phone, a smart pad, a smart watch, a tablet PC, a car navigation system, a laptop, a head mounted display (HMD) device, and the like.

The processor 1010 may perform various computing functions or various tasks. The processor 1010 may be a micro-processor, a central processing unit (CPU), an application processor (AP), and the like. The processor 1010 may be coupled to other components via an address bus, a control bus, a data bus, etc. Further, the processor 1010 may be coupled to an extended bus such as a peripheral component interconnection (PCI) bus.

The processor 1010 may output the input image data IMG1, the input control signal CONT1, the second input image data IMG2 and the second input control signal CONT2 to the driving controller 201 and the second driving controller 202 of FIG. 2.

The processor 1010 may output the input image data IMG and the input control signal CONT to the driving controller 200 of FIG. 18.

The memory device 1020 may store data for operations of the electronic apparatus 1000. For example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, and the like and/or at least one volatile memory device such as a dynamic random access memory (DRAM) device, a static random access memory (SRAM) device, a mobile DRAM device, and the like.

The storage device 1030 may include a solid state drive (SSD) device, a hard disk drive (HDD) device, a CD-ROM device, and the like. The I/O device 1040 may include an input device such as a keyboard, a keypad, a mouse device, a touch-pad, a touch-screen, and the like and an output device such as a printer, a speaker, and the like. In some embodiments, the display apparatus 1060 may be included in the I/O device 1040. The power supply 1050 may provide power for operations of the electronic apparatus 1000. The display apparatus 1060 may be coupled to other components via the buses or other communication links.

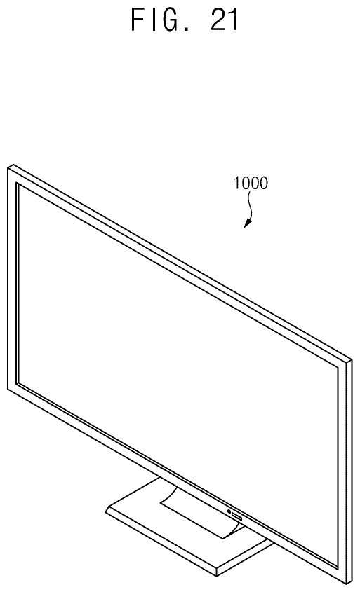

FIG. 21 is a diagram illustrating an example in which the electronic apparatus 1000 of FIG. 19 is implemented as a monitor.

Referring to FIGS. 19 and 21, the electronic apparatus 1000 may be implemented as a monitor.

According to the embodiments of the display apparatus and the electronic apparatus including the display apparatus, the perception degree of the motion blur of the display panel is relatively reduced so that the display quality may be enhanced and the dizziness may be relatively reduced.

The foregoing is illustrative of the present disclosure and is not to be construed as limiting thereof. Although a few embodiments of the present disclosure have been described, those skilled in the art will readily appreciate that many modifications are possible in the embodiments without materially departing from the novel teachings and characteristics of embodiments according to the present disclosure. Accordingly, all such modifications are intended to be included within the scope of the present disclosure as defined in the claims. In the claims, means-plus-function clauses are intended to cover the structures described herein as performing the recited function and not only structural equivalents but also equivalent structures. Therefore, it is to be understood that the foregoing is illustrative of the present disclosure and is not to be construed as limited to the specific embodiments disclosed, and that modifications to the disclosed embodiments, as well as other embodiments, are intended to be included within the scope of the appended claims. Embodiments according to the present disclosure are defined by the following claims, with equivalents of the claims to be included therein.

What is claimed is:

1. A display apparatus comprising:
a display panel;
an eye tracker configured to track a view of a user; and
a display panel driver configured to determine a central viewing area of the display panel and a peripheral viewing area of the display panel based on the view of the user, to drive the central viewing area of the display panel at a first duty ratio, and to drive the peripheral viewing area of the display panel at a second duty ratio,
wherein the first duty ratio is less than the second duty ratio.

2. The display apparatus of claim 1, wherein the display panel driver is configured to analyze input image data to determine a first mode and a second mode,
wherein, in the first mode, the display panel driver is configured to drive the central viewing area of the display panel at the first duty ratio and to drive the peripheral viewing area of the display panel at the second duty ratio, and
wherein, in the second mode, the display panel driver is configured to drive an entire display area of the display panel at the first duty ratio.

3. The display apparatus of claim 2, wherein, in the first mode, backgrounds of an image are fixed and an object moves in the backgrounds.

4. The display apparatus of claim 2, wherein, in the second mode, backgrounds of an image change.

5. The display apparatus of claim 1, wherein the display panel driver comprises an emission driver configured to output an emission signal to the display panel, and
wherein the emission driver is configured to apply the emission signal having the first duty ratio to the central viewing area and the emission signal having the second duty ratio to the peripheral viewing area.

6. The display apparatus of claim 1, further comprising:
a second display panel adjacent to the display panel;
a second eye tracker configured to track a second view of the user; and
a second display panel driver configured to determine a central viewing area of the second display panel and a peripheral viewing area of the second display panel based on the second view of the user, to drive the central viewing area of the second display panel at the first duty ratio, and to drive the peripheral viewing area of the second display panel at the second duty ratio.

7. The display apparatus of claim 6, wherein the display panel corresponds to a left eye of the user, and
wherein the second display panel corresponds to a right eye of the user.

8. The display apparatus of claim 6, wherein the display panel driver comprises:
a gate driver configured to output a gate signal to the display panel;
a data driver configured to output a data voltage to the display panel;
an emission driver configured to output an emission signal to the display panel; and
a driving controller configured to control the gate driver, the data driver and the emission driver, and
wherein the second display panel driver comprises:
a second gate driver configured to output a second gate signal to the second display panel;
a second data driver configured to output a second data voltage to the second display panel;
a second emission driver configured to output a second emission signal to the second display panel; and
a second driving controller configured to control the second gate driver, the second data driver and the second emission driver.

9. The display apparatus of claim 6, wherein the display panel driver comprises:
a gate driver configured to output a gate signal to the display panel;
a data driver configured to output a data voltage to the display panel; and
an emission driver configured to output an emission signal to the display panel,
wherein the second display panel driver comprises:
a second gate driver configured to output a second gate signal to the second display panel;
a second data driver configured to output a second data voltage to the second display panel; and
a second emission driver configured to output a second emission signal to the second display panel, and
wherein the display panel driver further comprises a driving controller configured to control the gate driver, the data driver, the emission driver, the second gate driver, the second data driver, and the second emission driver.

10. The display apparatus of claim 1, wherein the display panel includes display blocks extending in a first direction and arranged in a second direction, and
wherein the display panel driver is configured to drive display blocks including the central viewing area of the display panel among all the display blocks at the first duty ratio and display blocks not including the central viewing area of the display panel among all the display blocks at the second duty ratio.

11. The display apparatus of claim 1, wherein the display panel includes first display blocks extending in a first direction and arranged in a second direction,
wherein the display panel further includes second display blocks extending in the second direction and arranged in the first direction,
wherein the display panel driver is configured to drive an area corresponding to an intersection of the first display blocks including the central viewing area of the display panel among all the first display blocks and the second display blocks including the central viewing area of the display panel among all the second display blocks at the first duty ratio, and
wherein the display panel driver is configured to drive an area not corresponding to the intersection at the second duty ratio.

12. A display apparatus comprising:
a display panel;
an eye tracker configured to track a view of a user; and
a display panel driver configured to determine a central viewing area of the display panel and a peripheral viewing area of the display panel based on the view of the user, to drive the central viewing area of the display panel at a first duty ratio and a first frequency, and to drive the peripheral viewing area of the display panel at a second duty ratio and a second frequency,
wherein the first duty ratio is different from the second duty ratio, or the first frequency is different from the second frequency.

13. The display apparatus of claim 12, wherein the first duty ratio is less than the second duty ratio, and
wherein the first frequency is equal to the second frequency.

14. The display apparatus of claim 12, wherein the first duty ratio is equal to the second duty ratio, and
wherein the first frequency is greater than the second frequency.

15. The display apparatus of claim 12, wherein the first duty ratio is less than the second duty ratio, and
wherein the first frequency is greater than the second frequency.

16. The display apparatus of claim 12, wherein the display panel driver is configured to analyze input image data to determine a first mode and a second mode,
wherein, in the first mode, the display panel driver is configured to drive the central viewing area of the display panel at the first duty ratio and the first frequency and to drive the peripheral viewing area of the display panel at the second duty ratio and the second frequency,
wherein, in the second mode, the display panel driver is configured to drive an entire display area of the display panel at the first duty ratio, and
wherein, in the second mode, the display panel driver is configured to drive the entire display area of the display panel at one of the first frequency and the second frequency.

17. The display apparatus of claim 12, wherein the display panel driver is configured to analyze input image data to determine a first mode and a second mode,
wherein, in the first mode, the display panel driver is configured to drive the central viewing area of the display panel at the first frequency and to drive the peripheral viewing area of the display panel at the second frequency, and
wherein, in the second mode, the display panel driver is configured to drive an entire display area of the display panel at one of the first frequency and the second frequency.

18. The display apparatus of claim 12, wherein the display panel driver comprises an emission driver configured to output an emission signal to the display panel, and
wherein the emission driver is configured to apply the emission signal having the first frequency to the central viewing area and the emission signal having the second frequency to the peripheral viewing area.

19. The display apparatus of claim 12, further comprising:
a second display panel adjacent to the display panel;
a second eye tracker configured to track a second view of the user; and
a second display panel driver configured to determine a central viewing area of the second display panel and a peripheral viewing area of the second display panel based on the second view of the user, to drive the central viewing area of the second display panel at the first frequency, and to drive the peripheral viewing area of the second display panel at the second frequency.

20. An electronic apparatus comprising:
a display panel;
an eye tracker configured to track a view of a user;
a display panel driver configured to determine a central viewing area of the display panel and a peripheral viewing area of the display panel based on the view of the user, to drive the central viewing area of the display panel at a first duty ratio, and to drive the peripheral viewing area of the display panel at a second duty ratio; and
a processor configured to output input image data and an input control signal to the display panel driver,
wherein the first duty ratio is less than the second duty ratio.
